(19) United States
(12) Patent Application Publication
(10) Pub. No.: US 2022/0211052 A1
(43) Pub. Date: Jul. 7, 2022

(54) Oven End Shroud Assembly

(71) Applicant: Wolfe Electric, Inc., Wichita, KS (US)

(72) Inventors: Brent Staver, Wichita, KS (US); Dale Kester, Wichita, KS (US); Jonathan Dukes, Wichita, KS (US)

(73) Assignee: Wolfe Electric, Inc., Wichita, KS (US)

(21) Appl. No.: 17/700,150

(22) Filed: Mar. 21, 2022

(51) Int. Cl. A21B 3/00; A21B 1/48

(52) U.S. Cl. CPC A21B 3/00; A21B 1/48

(57) ABSTRACT

An oven hood assembly for shrouding a longitudinal end of a tunnel oven stack, wherein each tunnel oven has longitudinal and oppositely longitudinal food passage ports, and has a food conveyor having ends extending longitudinally and oppositely longitudinally from one of the tunnel ovens' longitudinal and oppositely longitudinal food passage ports; the assembly incorporating a channel member having front and rear walls, and having a longitudinal wall spanning between longitudinal ends of the front and rear walls; having a pair of lower tracks supported beneath the longitudinal end of one of the conveyors; and having a pair of upper tracks supported at an upper end of the channel member, wherein the pair of upper tracks engage the pair of lower tracks to suspend the channel member from the conveyor's longitudinal end, and to facilitate motions of the channel member along the pair of lower tracks.

### FIELD OF THE INVENTION

This invention relates to oven hoods which are specially adapted for collecting smoke and heated gasses emitting from the food passage ports of vertically stacked conveyor tunnel ovens. More particularly, this invention relates to such assemblies which are adapted for shrouding food passage ports opening at the longitudinal and oppositely longitudinal ends of such tunnel oven stacks.

### BACKGROUND OF THE INVENTION

Vertically stacked conveyor tunnel ovens are known to incorporate oven hood end shroud assemblies which functionally form a vertical channel for upwardly conveying smoke and cooking exhaust gasses emitting from the oven's longitudinal and oppositely longitudinal food passage ports. Such oven hood end shroud assemblies are known to be vertically segmented and to fixedly attach their vertical segments to longitudinal and oppositely longitudinal food conveyor ends which conventionally extend from the oven's longitudinal and oppositely longitudinal food passage ports. Such known vertically segmented end shrouds are often difficult to install and de-install, and such known shroud assemblies often undesirably interfere with oven operators' access to crumb catching trays which may be mounted upon the conveyors, immediately beneath their longitudinally and oppositely longitudinally extending ends.

The instant inventive oven end shroud assembly solves or ameliorates the problems, defects, and deficiencies noted above by providing specialized mounting brackets which multiply function for suspending the end shroud segments, and for facilitating horizontal sliding shroud segment installations and de-installations.

### BRIEF SUMMARY OF THE INVENTION

The instant inventive oven hood assembly is intended for use in shrouding the longitudinal end and/or the oppositely longitudinal end of a stack of conveyor tunnel ovens. Each oven among the stack of conveyor tunnel ovens conventionally comprises a baking case having longitudinal and oppositely longitudinal food passage ports which open the stacked cases at their longitudinal and oppositely longitudinal ends. Each stacked tunnel oven case also conventionally includes a longitudinally extending continuous loop grate type food conveyor having longitudinal and oppositely longitudinal ends. Such longitudinal and oppositely longitudinal conveyor ends conventionally respectively extend or cantilever longitudinally and oppositely longitudinally from the baking cases' longitudinal and oppositely longitudinal food passage ports. In an alternate configuration of the food conveyor, the longitudinal and oppositely longitudinal conveyor ends comprise fixed shelf configured slide surfaces, with the medial portion of the conveyor (i.e. a portion of the conveyor substantially completely residing within and spanning longitudinally across the interior of the baking case) being continuous loop in character. In the conventional configuration the cantilevering longitudinal and oppositely longitudinal extensions of the continuous loop conveyor are supported by extensions of the conveyor's peripheral rectangular frames or chassis, and such frame advantageously provides structural mounting support for attachment of oven hood end shroud segments. In the alternative configuration, the similarly cantilevering slide shelves alternatively provide such structural mounting support.

The instant inventive assembly attaches to such longitudinal and oppositely longitudinal conveyor extensions, the assembly comprising at least a first end shroud channel member which is preferably configured in the form of a “C” channel. The at least first “C” channel configured member preferably forms a vertically extending channel path which has open upper and lower ends. In operation, each “C” channel member convectively conveys smoke and gas which emits from an oppositely longitudinal underlying conveyor oven food passage port. Such conveyor tunnel oven preferably comprises a single stratum of a stack of or strata of similarly configured conveyor tunnel conveyor ovens.

The inventive assembly's at least first “C” channel member preferably further opens oppositely longitudinally toward the tunnel oven's longitudinal food passage port. To form its preferred “C” configuration, the at least first “C” channel member preferably has a front wall or flange, a rear wall or flange, and has a longitudinal wall or web which spans laterally between and rigidly interconnects longitudinal ends of the front and rear walls. The at least first channel member may suitably alternatively form an open topped and open bottom box which further includes an oppositely longitudinal wall. However, for purposes of materials economy and enhanced convective air flow, a “C” channel configuration is preferred. In such preferred embodiment, the walls of the at least first “C” channel configured member are composed of heavy gauged stainless steel sheet metal.

Further structural components of the instant inventive oven hood assembly comprise at least a first pair of lower tracks which are attached to and are fixedly supported beneath the longitudinally protruding longitudinal end of the oven stack's immediately overlying food conveyor. For example, where the instant inventive oven hood assembly serves a three member strata or stack of conveyor tunnel ovens, the assembly's at least first pair of lower tracks is suitably mounted upon and beneath the longitudinal conveyor extension which cantilevers from one of the upper oven cases within the stack. In a preferred embodiment, each track among the first pair of lower tracks comprises a horizontally extending foot or flange of a laterally oblongated “L” hook which spans the front to rear width of such longitudinal conveyor extension.

A further structural component of the instant inventive assembly comprises a first pair of upper tracks which is attached to or fixedly supported at an upper end of the first “C” channel member. Similarly with the preferred “L” hook configuration of the first pair of lower tracks, the assembly's corresponding upper tracks are configured as oppositely extending flange or foot “L” hook components.

The first pair of upper tracks is preferably inverted and is mirroringly configured with respect to the first pair of lower tracks. In such configuration, the downwardly facing surfaces of the flanges or feet of the first pair of upper tracks advantageously slidably bear against upwardly facing surfaces of the flanges or feet of the first pair of lower tracks. Similarly with the extensions of the first pair of lower tracks, the assembly's first pair of upper tracks preferably extend laterally so that, upon hooking engagements of the first pair of upper tracks with the immediately underlying first pair of lower tracks, the first “C” channel member is effectively suspended from the immediately overlying longitudinal conveyor extension, and so that the first “C” channel member may laterally and telescopingly slidably move parallel to and along the lower tracks' lateral extensions. Such sliding motions are between end shroud segment use and de-installed positions, facilitating convenient attachments and detachments of the “C” channel member.

In a suitable alternative embodiment of the inventive assembly, the pairs of upper and lower tracks may alternatively extend longitudinally to perform the same “C” channel suspending function, and to alternatively facilitate longitudinal movements between the end shroud segment use and de-installed positions. Where multiple tunnel conveyor ovens are included within the stack of ovens to be end shrouded by the instant inventive assembly, structures described above may be vertically replicated in order to similarly shroud the longitudinal food passage ports of other ovens within the stack. Also, oppositely longitudinal end structures which mirroringly replicate the longitudinal end structures described above may be advantageously attached to and reside at the longitudinal ends of the stacked ovens. Such oppositely longitudinal and shroud channel members preferably function substantially identically with the longitudinal channel members to shroud the ovens' oppositely longitudinal food passage ports.

At the installed locations of the above described pairs of lower tracks, a crumb catching tray supported by crumb tray brackets or hangers may be conventionally installed. Such crumb tray brackets or hangers may be conveniently utilized for dually functioning as the instant invention's first pairs of lower tracks, and as crumb tray supporting members. In such dual function aspect of the inventive assembly, upwardly facing surfaces of the flanges or feet of the upper pairs of tracks may alternatively serve as crumb tray slide mount surfaces. In such alternative function and service, a crumb tray may advantageously rest upon upper surfaces of the upper tracks while those tracks' lower surfaces directly rest upon the lower tracks.

Where the instant invention's upper tracks additionally function as crumb tray slide mounts, crumb tray access ports may be advantageously formed within the front walls of the “C” channel members so that the crumb trays may be conveniently slidably installed or de-installed without the necessity of preliminarily de-installing the “C” channel member.

Accordingly, objects of the instant invention include the provision of an oven end shroud assembly for upwardly conveying smoke or gas at the ends of stacked tunnel ovens which incorporates structures as described above, and which arranges those structures in manners described above, for the achievement of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive oven hood assembly for shrouding ends of a stack of tunnel ovens, the view additionally showing a stack of conveyor tunnel ovens served by the assembly and additionally showing an overlying exhaust hood.

FIG. 2 redepicts the structure of FIG. 1, the view of FIG. 2 showing one of the “C” channel end shroud segments partially slidably forwardly de-installed.

FIG. 3 redepicts the structure of FIG. 2, the view of FIG. 3 showing one of the “C” channel shroud members completely de-installed.

FIG. 4 is a magnified view of a portion of the assembly of FIGS. 1-3, the view of FIG. 4 showing a lower track pair component of the assembly.

FIG. 5 is an alternative perspective view of the structure of FIG. 4, the view of FIG. 5 showing a crumb catching tray slidably supported by the lower track pair component of the assembly.

FIG. 6 is a perspective view of one of “C” configured channel members of the instant inventive assembly, the view showing an attached upper track pair.

FIG. 7 is a partial front view of the structure of FIG. 1, the view of FIG. 7 showing an opened crumb tray access port.

FIG. 8 redepicts the structure of FIG. 7, the view of FIG. 8 additionally showing an installed crumb catching tray.

### DETAILED DESCRIPTION OF A PREFERRED EMBODIMENT

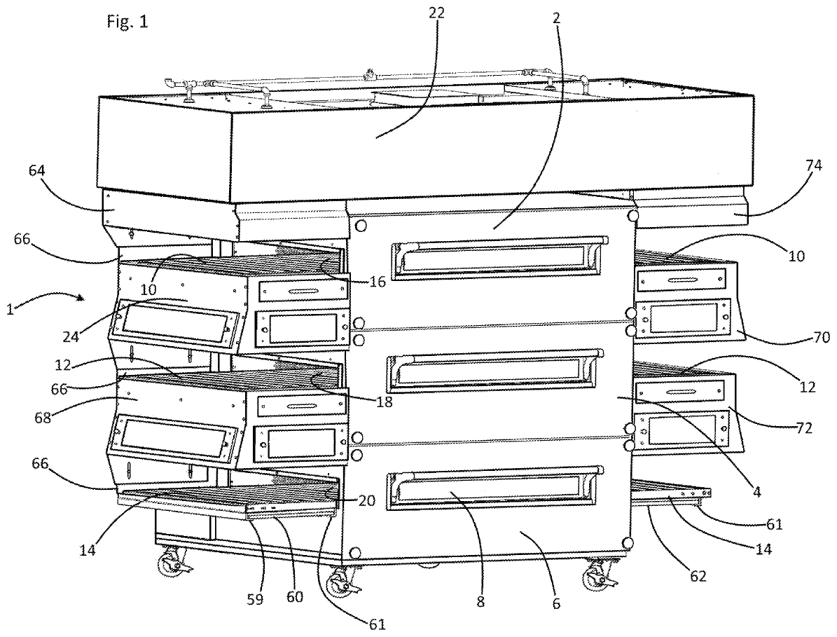

Referring now to the drawings and in particular to Drawing FIG. 1, a preferred embodiment of the instant inventive oven hood assembly is referred to generally by Reference Arrow 1. A stack of tunnel conveyor ovens include oven cases 2, 4, and 6, whose food passage ports are served by the inventive assembly 1.

Each oven among the stack 2,4,6 has longitudinal and oppositely longitudinal food passage ports. Longitudinal food passage ports 16, 18, and 20 are within the view of Drawing FIG. 1. Mirroringly configured oppositely longitudinal food passage ports similarly open the baking cases 2, 4, and 6 at those cases' oppositely longitudinal ends or walls.

Each of the cases among the stack 2,4,6 includes and supports a longitudinally extending continuous loop and cooking grate configured food conveyor. Food conveyor 10 extends longitudinally through the uppermost baking case 2, food conveyor 12 extends longitudinally through middle case 4, and a lowermost food conveyor 14 extends longitudinally through the lower baking case 6. Each of the continuous loop food conveyors includes cantilevering longitudinal and oppositely longitudinal ends which protrude or extend from the longitudinal and oppositely longitudinal food passage ports. Each of the baking cases 2, 4, and 6 also has a pivoting front sandwich access door 8. An upper exhaust hood 22 is supported upon the upper end of the uppermost oven case 2.

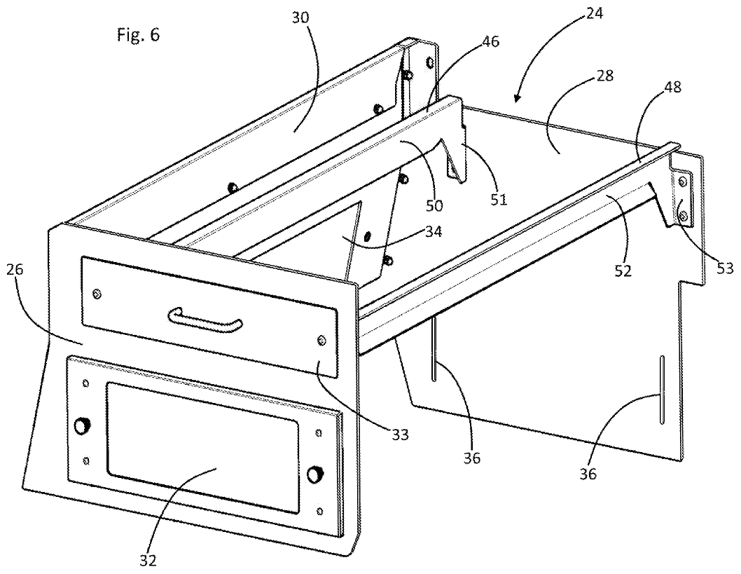

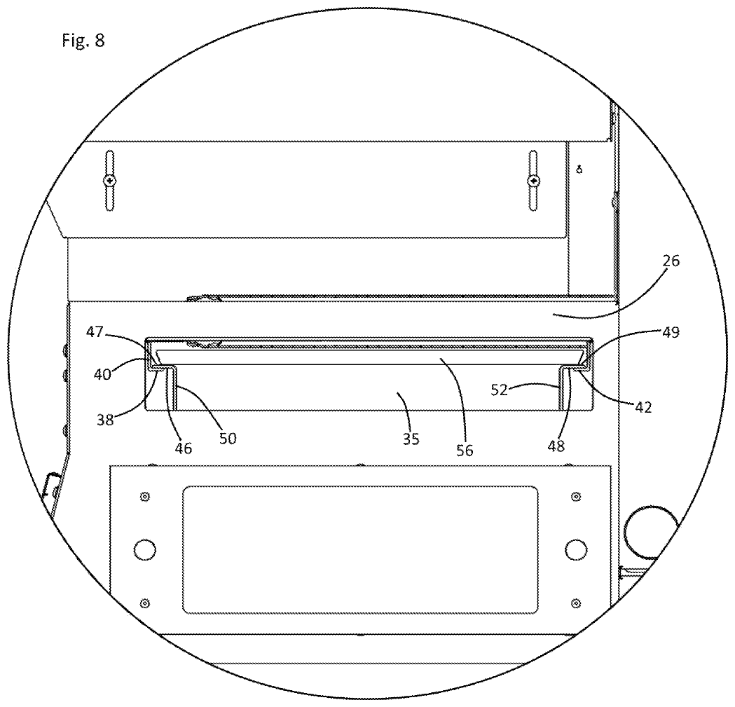

Referring simultaneously to FIGS. 1-3 and 6-8, the instant inventive oven hood assembly comprises at least a first channel member which is referred to generally in Drawing FIG. 6 by Reference Arrow 24. Such channel member 24 is preferably configured to form a “C” channel which defines a vertical air convection channel. Such preferred “C” channel configured member 24 has a rear wall or flange 28, and has a laterally opposed front wall or flange 26. A longitudinal wall or “C” channel web 30 spans between and rigidly interconnects the longitudinal ends of the front and rear walls 26 and 28. The channel member 24 may suitably further comprise an oppositely longitudinal wall (not depicted within views) which spans between oppositely longitudinal ends of the front and rear walls 26 and 28. Notwithstanding, such additional wall is preferably omitted for purposes of materials economy, and to reduce interference with longitudinal and upward flows of smoke and gasses which emit from the food passage ports. As shown in FIG. 6, the first “C” channel member 24 has open upper and lower ends for guiding vertical heat convection air flows along the oppositely longitudinal end of the oven stack and toward the overlying exhaust hood 22.

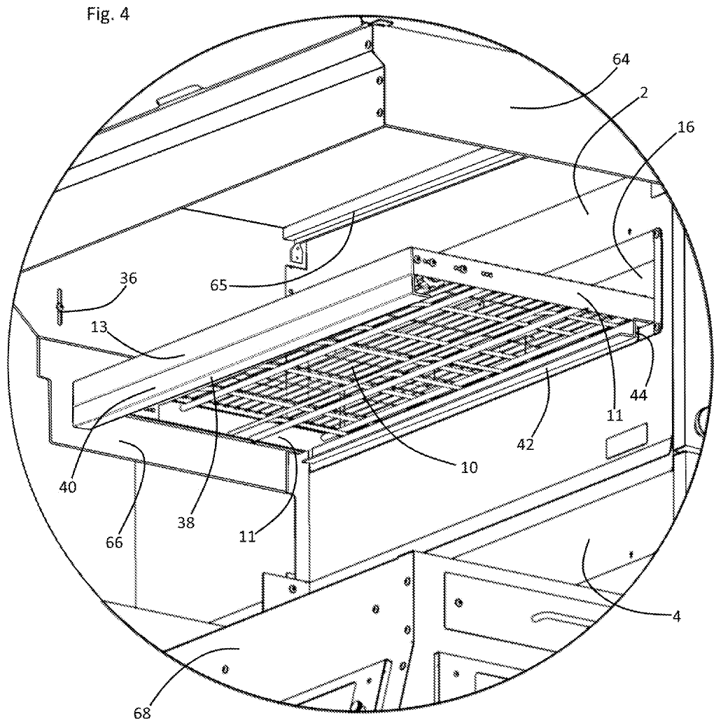

Referring to FIG. 4, a further structural component of the instant inventive oven hood assembly comprises at least a first pair of lower tracks 38 and 42. In the preferred embodiment, such pair of lower tracks 38 and 42 is rigidly supported immediately beneath the longitudinal extension of the continuous loop food conveyor 10 of the uppermost oven case 2. In the depicted embodiment, such tracks 38 and 42 extend laterally and comprise horizontally extending flange or foot components of a pair of “L” hooks 40 and 44.

Where the continuous loop food conveyor 10 presents front and rear conveyor frame rails 11, the “L” hook member 44 including its lower track component 42 may be welded to such front and rear rails. As shown in Drawing FIG. 4, the longitudinally opposite lower track 38 constitutes a component of a wholly or integrally formed “L” hook 40, the downward extension of such hook being continuous with longitudinal frame rail 13.

Referring simultaneously to FIGS. 4 and 6, the instant inventive assembly preferably further comprises at least a first pair of upper tracks 46 and 48, such tracks 46 and 48 suitably comprising foot or flange components of relatively inverted “L” hooks 50 and 52. Front and rear mounts 51 and 53 are preferably provided for rigidly interconnecting the “L” hooks 50 and 52 along with their upper tracks 46 and 48 to the front and rear walls 26 and 28 of the “C” channel member 24. Such “L” hooks 50 and 52 are preferably positioned at the upper end of the “C” channel member 24 in order to facilitate suspension of the member from conveyor 10.

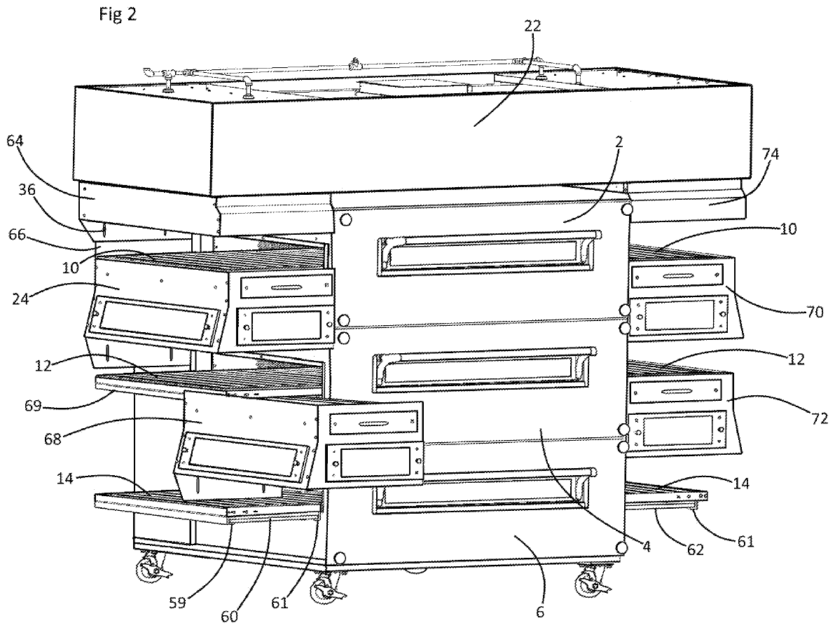

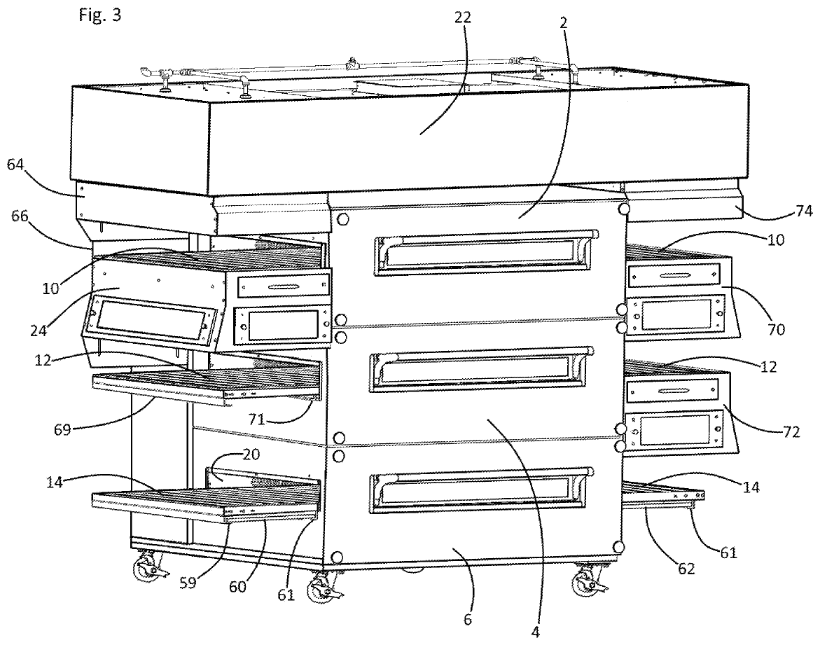

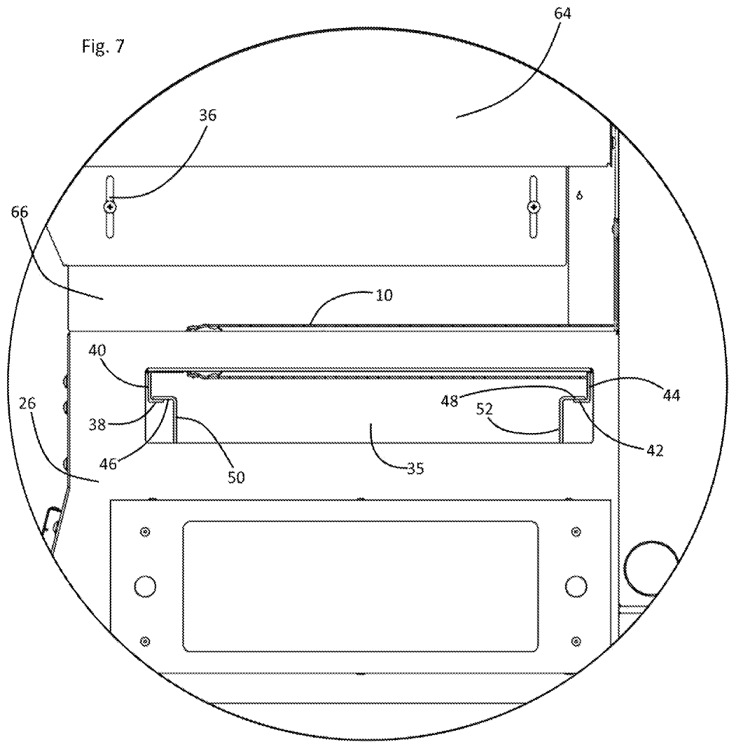

Referring further simultaneously to FIG. 7, the first pair of upper tracks 46 and 48 hookingly engages the first pair of lower tracks 38 and 42, effectively suspending the “C” channel member 24 from the cantilevering longitudinal extension of conveyor 10. The depicted engagements of “L” hooks 50 and 52 with “L” hooks 40 and 44, advantageously holds the “C” channel member 24 in its installed position as depicted in FIGS. 1-3. In performance of an additional function of “L” hooks 50,52,40,44, a frontward pulling force applied to the “C” channel member 24 advantageously slidably forwardly de-installs the “C” channel member 24 from the suspended use configuration of FIG. 1. Such facilitated lateral sliding de-installation of member 24 suitably proceeds in the manner depicted in Drawing FIG. 2 to completely de-install the member 24 as indicated in FIG. 3.

Referring simultaneously to FIGS. 6 and 7, view windows 32 and 34 are preferably installed on the “C” channel member's front and longitudinal walls 26 and 30, such windows 32 and 34 allowing an operator of the oven to better see food items as they enter or exit the ovens.

A crumb tray access port 35 preferably opens the “C” channel member 24 at its front wall 26, such port being selectively openable and closeable by a removable cover cap 33. The functions of the crumb tray port 35 and its cap 33 are further discussed below.

The immediately underlying second “C” channel member 68 is preferably configured substantially identically with the overlying first “C” channel member 24. Such other or another “C” channel member 68 preferably has additional or other pairs of upper and lower tracks which are preferably formed integrally with “L” hooks, such other tracks preferably being configured substantially identically with the first pairs of tracks described above.

Oppositely longitudinally mirroring “C” channel members 70 and 72 are preferably further provided, such members 70 and 72 being suspended from oppositely longitudinal extensions of conveyors 10 and 12 via similarly configured oppositely longitudinal pairs of upper and lower tracks. Oppositely longitudinal shroud segment structures depicted in FIGS. 1-3 are preferably configured substantially identically and mirroringly with the longitudinal and shroud components described above.

Referring to FIGS. 1-3, it may be seen that the upper hood 22 includes a longitudinal and oppositely longitudinal extension beyond the longitudinal and oppositely longitudinal ends of the oven stack 2,4,6. Such upper hood extensions vertically overlie the longitudinal and oppositely longitudinal extensions of the food conveyors 10, 12, and 14, and such extensions advantageously similarly perform end shroud supporting functions. Uppermost exhaust gas and smoke conveying channel members 64 and 74 are suitably provided and installed upon such upper hood extensions, such installations preferably utilizing the same type of “L” hook adapted slide mount attachment described above with respect to “C” channel members 24, 68, 70, and 72. Referring to FIG. 4, engaged lower and upper “L” hooks 65 similarly slidably suspend the upper channel member 64. Accordingly, upper “C” channel members 64 and 74 may be slidably frontwardly and rearwardly installed and de-installed in the same manner as, referring to FIG. 2, the depicted sliding installation or de-installation of “C” channel member 68.

Gap covering panels 66 are preferably provided to close air escape routes which reside between the rearward ends of the conveyors 10, 12, and 14, and the lower edges of the “C” channel member's rear walls. Such gap covering panels 66 are suitably adjustably installed by means of adjustment slot and bolt combination fasteners 36. In order to slidably forwardly de-install one of the “C” channel members 24, 68, 70, or 72, such member's gap covering panel 66 may be preliminarily removed.

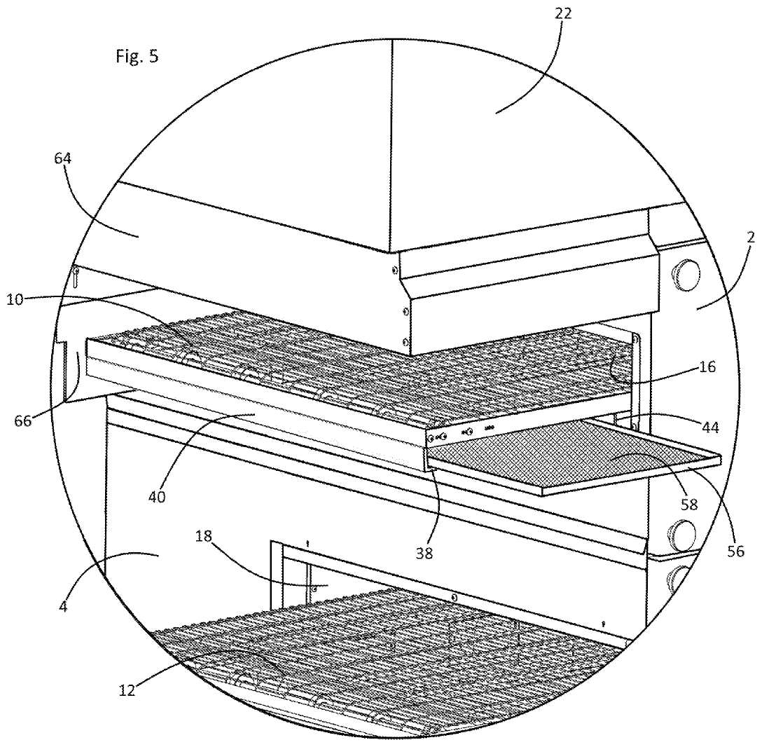

Referring to FIGS. 1-3, lower crumb catching trays 60 and 62 may be conventionally installed immediately beneath the longitudinal and oppositely longitudinal extensions of the lower food conveyor 14, such crumb trays 60 and 62 being slidably installed upon and retained by laterally extending “L” hook pairs 59,61. Referring further to FIG. 5, a similarly configured crumb catching tray 56 having a perforate floor 58 may be similarly installed upon and slidably supported by the “L” hook pair 40,44, which hooks include the assembly's first pair of lower tracks 38 and 42. Upon the above described installation of the “C” channel member 24 upon “L” hooks 40 and 44, the assembly's upper pair of tracks 46 and 48 directly contact and rest upon the upper surfaces of the lower pair of tracks 38 and 42. Accordingly, upon such “C” channel member installation, such lower tracks 38 and 40 cannot directly slidably support the crumb tray 56. Notwithstanding, such installation of “C” channel member 24 advantageously causes the upper surfaces 47 and 49 of the upper pair of tracks 46 and 48 to be immediately available for service as alternative crumb tray slide mount supports. Accordingly, the instant inventive lateral sliding mode of attachment and support of the “C” channel members is mechanically consistent with continued use of the conveyor mounted “L” hooks 40 and 44 for crumb tray installation and support.

In order to allow the crumb tray 56 to be accessed, installed, and removed without the necessity of de-installing the “C” channel member 24, an access port 35 is preferably formed within front wall 26, such port 35 being covered and closed by the removable plug or cap 33. Each of the longitudinal and oppositely longitudinal “C” channel members 24, 68, 70, and 72 is preferably adapted, as indicated above, for performing dual functions of “C” channel member support and independent sliding installations and de-installations of crumb trays.

While the upper and lower track components of the instant invention are preferably configured as laterally extending “L” hook feet or flanges, as depicted in FIGS. 4 and 6, various other track configurations are considered to fall within the scope of the invention. For example, the abutting surfaces of the vertically engaged tracks may be adapted to present wheels or rollers (not depicted within views) for friction reduction. Further alternatively, the invention's lower track components may suitably be configured to present an upwardly opening and laterally extending slide channel(not depicted within views), such channel downwardly receiving a laterally extending flange edge configured track (also not depicted within views).

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. An oven hood assembly for shrouding a longitudinal end of a stack of tunnel ovens, each tunnel oven among the stack of tunnel ovens comprising a case opened by longitudinal and oppositely longitudinal food passage ports, said each tunnel oven further having a food conveyor having longitudinal and oppositely longitudinal ends respectively extending longitudinally and oppositely longitudinally from one of the longitudinal food passage ports and from one of the oppositely longitudinal food passage ports, the oven hood assembly comprising:
(a) a channel member having a front wall, a rear wall, and a longitudinal wall spanning between longitudinal ends of the front and rear walls;
(b) a pair of lower tracks fixedly supported beneath the longitudinal end of one of the tunnel ovens' food conveyors; and
(c) a pair of upper tracks fixedly supported at an upper end of the channel member, wherein the pair of upper tracks engage the pair of lower tracks to suspend the channel member from said conveyor longitudinal end, and to facilitate motions of the channel member along the pair of lower tracks.

2. The oven hood assembly of claim 1 wherein the channel member comprises a “C” channel.

3. The oven hood assembly of claim 2 further comprising another “C” channel configured member, said member having a front wall, a rear wall, and a longitudinal wall spanning between longitudinal ends of said front and rear walls; another pair of lower tracks fixedly supported beneath the longitudinal end of another one of the tunnel ovens' food conveyors; and another pair of upper tracks fixedly supported at an upper end of the another “C” channel configured member; wherein the another pair of upper tracks engages the another pair of lower tracks to suspend the another “C” channel configured member from the longitudinal end of the another one of the tunnel oven's food conveyors, and to facilitate motions of the another “C” channel configured member along the another pair of lower tracks.

4. The oven hood assembly of claim 3 wherein each pair of lower tracks extends laterally.

5. The ovenn hood assembly of claim 4 wherein each pair of upper tracks extends laterally.

6. The oven hood assembly of claim 5 wherein each track among the pairs of upper and lower tracks comprises a slide flange.

7. The oven hood assembly of claim 6 wherein each of the upper tracks' slide flanges has a laterally extending upper slide surface, and further comprising at least a first crumb tray, the at least first crumb tray being slidably mounted upon a pair of the laterally extending upper slide surfaces.

8. The oven hood assembly of claim 7 further comprising at least a first crumb tray access port, said port opening one of the “C” channels at said channel's front wall.

9. The oven hood assembly of claim 8 further comprising at least a first crumb tray port cover connected operatively to the front wall of said one of the “C” channels.

10. The oven hood assembly of claim 6 further comprising oppositely lateral pairs of upper tracks and lower tracks and an oppositely lateral plurality of “C” channel members, the oppositely lateral pairs of upper tracks and lower tracks being supported at the oppositely lateral end of the tunnel oven stack, wherein the oppositely lateral pairs of upper tracks engage the oppositely lateral pairs of lower tracks to suspend the oppositely lateral plurality of “C” channel members from the food conveyors' oppositely lateral ends, and to facilitate motions of the oppositely lateral plurality of “C” channel members along the oppositely lateral pairs of lower tracks.
